(19) United States
(12) Patent Application Publication
(10) Pub. No.: US 2021/0138793 A1
(43) Pub. Date: May 13, 2021

(54) LIQUID ABSORPTION SYSTEM, LIQUID ABSORPTION UNIT, AND IMAGE FORMING APPARATUS

(71) Applicant: SEIKO EPSON CORPORATION, Tokyo (JP)

(72) Inventor: Yoichi MIYASAKA, Suwa (JP)

(21) Appl. No.: 17/089,761

(22) Filed: Nov. 5, 2020

(30) Foreign Application Priority Data
Nov. 7, 2019 (JP) 2019-202167

(51) Int. Cl. B41J 2/17

(52) U.S. Cl. CPC B41J 2/1721

(57) ABSTRACT

A liquid absorption system includes a pipe which transports a liquid containing metal ions; a discharge portion which discharges the liquid transported by the pipe; a container which recovers the liquid discharged from the discharge portion; an absorbing portion which is received in the container and which includes a polymer absorbent absorbing the liquid; and a metal ion-concentration decrease portion which decreases a concentration of the metal ions contained in the liquid, and the metal ion-concentration decrease portion is provided at a position at which the metal ion-concentration decrease portion comes in contact with the liquid before the liquid comes in contact with the absorbing portion.

The present application is based on, and claims priority from JP Application Serial Number 2019-202167, filed Nov. 7, 2019, the disclosure of which is hereby incorporated by reference herein in its entirety.

### BACKGROUND

### 1. Technical Field

The present disclosure relates to a liquid absorption system, a liquid absorption unit, and an image forming apparatus.

### 2. Related Art

In an ink jet printer, for example, when a head cleaning operation is performed in order to prevent degradation in printing quality due to ink clogging, and/or when an ink filling operation is performed after ink cartridge exchange, a waste ink is generated. In order to absorb the waste ink as described above, the ink jet printer includes a liquid absorber containing a liquid absorbent.

For example, JP-A-2007-8126 has discloses a waste ink absorbent containing a water absorbing polymer. According to the waste ink absorbent as described above, a waste ink is absorbed by the water absorbing polymer, and at the same time, the waste ink thus absorbed is retained.

However, the waste ink absorbent disclosed in JP-A-2007-8126 has been considered assuming that a pigment ink is mainly used. Hence, when a dye ink is absorbed in the waste ink absorbent disclosed in the above patent document, the absorption amount is disadvantageously decreased. As for the reason thereof, the present inventor found that metal ions contained in the dye ink decreases the absorption amount of the waste ink absorbent. In consideration of the finding described above, while waste liquid retention characteristics by a water absorbing polymer is utilized, a liquid absorption system or a liquid absorption unit which is also used for a liquid, such as a dye ink, containing metal ions has been desired to be developed.

### SUMMARY

According to an aspect of the present disclosure, there is provided a liquid absorption system comprising: a pipe which transports a liquid containing metal ions; a discharge portion which discharges the liquid transported by the pipe; a container which recovers the liquid discharged from the discharge portion; an absorbing portion which is received in the container and which includes a polymer absorbent absorbing the liquid; and a metal ion-concentration decrease portion which decreases a concentration of the metal ions contained in the liquid. In the liquid absorption system described above, the metal ion-concentration decrease portion is provided at a position at which the metal ion-concentration decrease portion comes in contact with the liquid before the liquid comes in contact with the absorbing portion.

According to another aspect of the present disclosure, there is provided a liquid absorption unit comprising: a container which recovers a liquid containing metal ions introduced from an introduction portion configured to introduce the liquid; an absorbing portion which is received in the container and which includes a polymer absorbent absorbing the liquid; and a metal ion-concentration decrease portion which is received in the container and which decreases a concentration of the metal ions contained in the liquid. In the liquid absorption unit described above, the metal ion-concentration decrease portion is provided at a position at which the metal ion-concentration decrease portion comes in contact with the liquid before the liquid comes in contact with the absorbing portion.

According to another aspect of the present disclosure, there is provided an image forming apparatus comprising: the liquid absorption system according to the present disclosure or the liquid absorption unit according to the present disclosure.

### BRIEF DESCRIPTION OF THE DRAWINGS

FIG. 1 is a partially vertical cross-sectional view showing an image forming apparatus and a liquid absorption system according to a first embodiment.

FIG. 2 is a view illustrating a small piece which forms an absorbing portion in FIG. 1.

FIG. 3 is a view illustrating the small piece which forms the absorbing portion in FIG. 1.

FIG. 4 is an enlarged cross-sectional view of a metal ion-concentration decrease portion shown in FIG. 1.

FIG. 5 is a view illustrating a method for manufacturing the absorbing portion of the liquid absorption system shown in FIG. 1.

FIG. 6 is a view illustrating the method for manufacturing the absorbing portion of the liquid absorption system shown in FIG. 1.

FIG. 7 is a view illustrating the method for manufacturing the absorbing portion of the liquid absorption system shown in FIG. 1.

FIG. 8 is a partially vertical cross-sectional view showing a liquid absorption system according to a second modified example.

FIG. 9 is a partially vertical cross-sectional view showing a liquid absorption system according to a third modified example.

FIG. 10 is a partially vertical cross-sectional view showing a liquid absorption unit according to a second embodiment.

FIG. 11 is a horizontal cross-sectional view of the liquid absorption unit shown in FIG. 10.

FIG. 12 is a partially vertical cross-sectional view showing a liquid absorption unit according to a fourth modified example.

### DESCRIPTION OF EXEMPLARY EMBODIMENTS

Hereinafter, a liquid absorption system, a liquid absorption unit, and an image forming apparatus according to the present disclosure will be described in detail with reference to embodiments shown in the attached drawings.

### 1. First Embodiment

First, an image forming apparatus and a liquid absorption system according to a first embodiment will be described.

### 1.1 Image Forming Apparatus

FIG. 1 is a partially vertical cross-sectional view showing the image forming apparatus and the liquid absorption system according to the first embodiment. In addition, in each drawing of the present disclosure, as three axes orthogonal to each other, an X axis, a Y axis, and a Z axis are set. In addition, the axes are each represented by an arrow, and a front end side and a base end side of the arrow are called “plus side” and “minus side”, respectively, of each axis. In addition, the Z-axis plus side and the Z-axis minus side are called “upper side” and “lower side”, respectively.

An image forming apparatus 200 shown in FIG. 1 is, for example, an ink jet type color printer. This image forming apparatus 200 includes a liquid absorption system 100 which recovers a waste liquid Q′ of an ink Q which is one example of a liquid.

The image forming apparatus 200 includes an ink ejection head 201 which ejects the ink Q, a capping unit 202 which prevents clogging of nozzles 201a of the ink ejection head 201, a tube 203 which couples the capping unit 202 and the liquid absorption system 100, a roller pump 204 which transports the ink Q from the capping unit 202, and a recovery portion 205.

The ink ejection head 201 has a plurality of nozzles 201a which eject the ink Q to the lower side. This ink ejection head 201 is able to perform printing by ejecting the ink Q while being transferred with respect to a recording medium, such as paper.

When the ink ejection head 201 is placed at a waiting position, by an operation of the roller pump 204, the capping unit 202 collectively sucks all the nozzles 201a. Accordingly, the ink Q is sucked from all the nozzles 201a, and the clogging of the nozzles 201a can be prevented.

The tube 203 is a pipe line which guides the ink Q sucked through the capping unit 202 to the liquid absorption system 100. This tube 203 has flexibility.

The roller pump 204 is disposed on the way of the tube 203 and has a rotatable roller portion 204a. Since the roller portion 204a rotates, the tube 203 is pressed, and a vacuum state is partially formed; hence, a suction force is generated in the capping unit 202. In addition, since the roller portion 204a continuously rotates, an ink Q which is adhered to the nozzles 201a can be transported to the recovery portion 205.

The recovery portion 205 includes a container 31, a pipe 36 which couples the tube 203 and the container 31, and an absorbing portion 34 received in the container 31. The ink Q is transported to the recovery portion 205 and is recovered as the waste liquid Q′.

As the ink Q, for example, there may be mentioned an aqueous ink in which a colorant is dissolved in an aqueous solvent, a solvent-based ink in which a binder is dissolved in a solvent, an UV curable ink in which a binder is dissolved in an liquid-phase monomer to be cured by UV (Ultra Violet) radiation, or a latex ink in which a binder is dispersed in a dispersion medium. Among those inks mentioned above, for example, a dye ink contains, besides metal ions, an organic solvent, a dye, and the like, water as a primary component.

In addition, as described above, in this embodiment, by the recovery portion 205, the liquid absorption system 100 is formed. Although the liquid absorption system 100 according to this embodiment absorbs the waste liquid Q′ of the ink Q, the liquid absorbed by the liquid absorption system 100 is not limited to the waste liquid Q′ of the ink Q, and other various types of liquids may also be absorbed.

### 1.2 Liquid Absorption System

The liquid absorption system 100 shown in FIG. 1 includes the pipe 36, a discharge portion 33 which discharges the waste liquid Q′, the container 31, the absorbing portion 34, and a metal ion-concentration decrease portion 35.

### 1.2.1 Pipe

The pipe 36 is coupled to the tube 203 with a connection portion 40 shown in FIG. 1 interposed therebetween. Accordingly, the waste liquid Q′ sucked through the tube 203 is transported to the pipe 36. In addition, the pipe 36 is coupled to the discharge portion 33 through the metal ion-concentration decrease portion 35 which will be described later. Hence, the waste liquid Q′ transported to the pipe 36 is further transported to the discharge portion 33 through the metal ion-concentration decrease portion 35. In addition, in the following description, a discharge portion 33 side and a tube 203 side of the pipe 36 are called “downstream” and “upstream”, respectively.

The connection portion 40 is a joint which couples the tube 203 and the pipe 36. The connection portion 40 may be configured to freely disengage the connection state between the tube 203 and the pipe 36, if needed. Accordingly, the liquid absorption system 100 may be fitted to or detached from a main body of the image forming apparatus 200. Hence, for example, when an absorption amount of the waste liquid Q′ reaches the limit of the liquid absorption system 100, an exchange operation for a new liquid absorption system 100 may be easily performed.

### 1.2.2 Container

The container 31 has a box shape having an approximately rectangular bottom portion 311 when viewed in plan from the above and four side wall portions 312 standing from the sides of the bottom portion 311 to the upper side. In addition, in a receiving space 313 surrounded by the bottom portion 311 and the four side wall portions 312, the absorbing portion 34 is received.

In addition, the container 31 is not limited to a container having an approximately rectangular bottom portion 311 when viewed in plan and may be, for example, a container having a round-shaped bottom portion 311 when viewed in plan and a cylindrical shape as a whole, and the bottom portion 311 may also have a polygonal shape or a shape different therefrom when viewed in plan.

Although the container 31 may have flexibility, the container 31 is preferably rigid. The rigid container 31 indicates a container having a rigidity such that its volume is not changed by 10% or more when an inside pressure or an outside pressure is applied thereto. The container 31 as described above is able to retain the shape thereof even when after the absorbing portion 34 absorbs the waste liquid Q′, a force generated by the expansion is applied to the container 31 from the inside. Accordingly, the installation state of the container 31 is stabilized in the image forming apparatus 200.

Although a constituent material of the container 31 is not particularly limited as long as not allowing the ink Q to pass therethrough, for example, there may be mentioned various types of resin materials, such as a cyclic polyolefin and a polycarbonate, and various types of metal materials, such as aluminum and stainless steel.

In addition, when being transparent or semi-transparent, the container 31 has an internal visibility; however, the container 31 may also be opaque.

When the volume of the receiving space 313 of the container 31 is represented by V1, and the total volume of the absorbing portion 34 before the waste liquid Q′ of the ink Q is absorbed is represented by V2, the ratio of V2 to V1, that is, the ratio V2/V1, is preferably 0.1 to 0.7 and more preferably 0.2 to 0.7. Accordingly, in the container 31, an air gap 315 is generated. Although the absorbing portion 34 may be expanded in some cases after the waste liquid Q′ of the ink Q is absorbed, the air gap 315 functions as a buffer when the absorbing portion 34 is expanded. Hence, the absorbing portion 34 can be sufficiently expanded, and the waste liquid Q′ can be sufficiently absorbed.

In addition, the liquid absorption system 100 shown in FIG. 1 included a lid 32 which covers the container 31.

The lid 32 has a plate shape and is able to liquid-tightly seal an upper opening 314 of the container 31. Accordingly, for example, even in the case in which after colliding on the absorbing portion 34, the waste liquid Q′ leaps up, the waste liquid Q′ can be prevented from scattering outside. In addition, the lid 32 may be formed integrally with the container 31, may have an air permeability at a sealing portion with the container 31, or may be omitted.

In the side wall portion 312 of the container 31, an insertion hole 316 is formed. The insertion hole 316 is a through-hole penetrating the side wall portion 312 in a thickness direction. In addition, in this insertion hole 316, the pipe 36 is inserted.

### 1.2.3 Discharge Portion

The discharge portion 33 discharges the waste liquid Q′ transported through the pipe 36 to the absorbing portion 34. The discharge portion 33 shown in FIG. 1 is provided most downstream of the pipe 36 with the metal ion-concentration decrease portion 35 to be described later interposed therebetween. In addition, the discharge portion 33 shown in FIG. 1 is provided on a bottom surface of the metal ion-concentration decrease portion 35 so as to face the lower side (Z-axis minus side). The waste liquid Q′ discharged from the discharge portion 33 drips right thereunder. In addition, the direction of the discharge portion 33 is not limited to that described above and may be different from the lower side.

### 1.2.4 Absorbing Portion

FIGS. 2 and 3 are each a view illustrating a small piece 2 which forms the absorbing portion 34 shown in FIG. 1.

The absorbing portion 34 shown in FIG. 1 is formed of an aggregate of the small pieces 2 shown in FIGS. 2 and 3. The small piece 2 includes, as shown in FIGS. 2 and 3, a base material 5 containing fibers and a water absorbing resin 4 which is a polymer absorbent supported by the base material 5. Since absorbing the waste liquid Q′ of the ink Q, the absorbing portion 34 suppresses leakage of the waste liquid Q′ from the liquid absorption system 100.

The small pieces 2 are obtained, for example, by cutting sheet-shaped waste paper which supports the water absorbing resin 4 into fine chip shapes with a shredder or the like. The small pieces 2 are each preferably a belt-shaped flexible piece. Accordingly, the small pieces 2 are easily deformed. Hence, when being received in the container 31, the small pieces 2 are deformed in accordance with the shape of the receiving space 313 of the container 31 and are easily received therein.

The entire length of the small piece 2, that is, the length of the long side thereof, is preferably 0.5 to 200 mm, more preferably 1 to 100 mm, and further preferably 2 to 30 mm.

The width of the small piece 2, that is, the length of the short side thereof, is preferably 0.1 to 100 mm, more preferably 0.3 to 50 mm, and further preferably 1 to 20 mm.

A ratio (aspect ratio) of the entire length to the width of the small piece 2 is preferably 1 to 200 and more preferably 1 to 30. The thickness of the small piece 2 is preferably 0.05 to 2 mm and more preferably 0.1 to 1 mm.

When the dimensions are each in the range described above, the support of the water absorbing resin 4, the retention of the waste liquid Q′ by the base material 5, and the transportation of the waste liquid Q′ to the water absorbing resin 4 can be more preferably performed. In addition, the absorbing portion 34 formed of the aggregate of the small pieces 2 is more likely to be deformed, and the shape followability to the container 31 can be improved. In addition, the shape of the small piece 2 is not limited to a chip shape and may be any other shape.

In the absorbing portion 34, small pieces 2 having the same value of at least one of the entire length, the width, the aspect ratio, and the thickness may be contained, or small pieces 2 having different values of all of those mentioned above may also be contained.

In the absorbing portion 34, the content of small pieces 2 having a maximum width of 3 mm or less is preferably 30 to 90 percent by mass and more preferably 40 to 80 percent by mass. Accordingly, absorbing characteristics of the waste liquid Q′ in the absorbing portion 34 can be suppressed from fluctuating.

In addition, if the content of the small pieces 2 having a maximum width of 3 mm or less is lower than the above lower limit, when the absorbing portion 34 is received in the container 31, large voids are liable to be formed between the small pieces 2, and the absorbing characteristics of the waste liquid Q′ in the absorbing portion 34 may fluctuate in some cases. On the other hand, if the content of the small pieces 2 having a maximum width of 3 mm or less is above the upper limit described above, voids are not likely to be formed between the small pieces 2, and hence, a bulk density of the absorbing portion 34 may be difficult to adjust in some cases.

The small pieces 2 may have irregular shapes but preferably have common regular shapes. Accordingly, the bulk density of the absorbing portion 34 is not likely to fluctuate, and the absorbing characteristics of the waste liquid Q′ can be suppressed from fluctuating. In the absorbing portion 34, the content of small pieces 2 having regular shapes in the total of the absorbing portion 34 is preferably 30 percent by mass or more, more preferably 50 percent by mass or more, and further preferably 70 percent by mass or more.

In the receiving space 313 of the container 31, the small pieces 2 are preferably randomly received so as not to have regularity in terms of the directions of the long sides. Accordingly, the voids are likely to be formed between the small pieces 2. As a result, the permeability of the waste liquid Q′ in the absorbing portion 34 can be more increased.

The bulk density of the absorbing portion 34 is preferably 0.01 to 0.5 g/cm³, more preferably 0.03 to 0.3 g/cm³, and further preferably 0.05 to 0.2 g/cm³. Accordingly, besides the permeability of the waste liquid Q′, the retention property thereof in association with a capillary phenomenon can be secured.

### 1.2.4.1 Fibers

As the fibers contained in the base material 5, for example, there may be mentioned synthetic resin fibers, such as polyester fibers or polyamide fibers, natural fibers, such as cellulose fibers (pulp fibers), keratin fibers, or fibroin fibers, or a chemical modified product thereof, and those fibers mentioned above may be used alone, or at least two types thereof may be used in combination.

Among those fibers mentioned above, as the polyester fibers, for example, there may be mentioned poly(ethylene terephthalate) (PET) fibers, poly(ethylene naphthalate) (PEN) fibers, poly(trimethylene terephthalate) (PTT) fibers, or poly(butylene terephthalate) (PBT) fibers.

In addition, as the polyamide fibers, for example, aliphatic polyamide fibers, such as nylon fibers, or aromatic polyamide fibers, such as aramid fibers, may be mentioned.

The cellulose fibers indicate fibers containing a cellulose as a chemical compound, that is, a cellulose in a narrow sense, as a primary component. In addition, the cellulose fibers may also contain, besides a cellulose, a hemicellulose and/or a lignin.

The fibers contained in the base material 5 are preferably cellulose fibers. Since the cellulose fibers are a material having a hydrophilic property, when being applied to the cellulose fibers, the waste liquid Q′ of the ink Q can be preferably permeated therethrough, and the waste liquid Q′ thus permeated can be efficiently transported to the water absorbing resin 4. In addition, since a cellulose generally has a high affinity to the water absorbing resin 4, the water absorbing resin 4 can be more preferably supported on the surface of the base material 5. In addition, the cellulose fibers are a regenerable natural raw material and, among various fibers, are easily available at an inexpensive price. For example, cellulose fibers derived from old paper are produced at a relatively low cost and also contribute to reduction of environmental load. Hence, in view of reduction of the production cost of the small pieces 2, stable production thereof, reduction of environmental load, and the like, the cellulose fibers are also advantageous.

As described above, the absorbing portion 34 according to this embodiment is preferably formed of the aggregate of the small pieces 2 each including the base material 5 containing cellulose fibers and the water absorbing resin 4, which is a polymer absorbent, supported by this base material 5.

According to the structure as described above, when the absorbing portion 34 is received in the container 31, an effect in that the absorbing portion 34 is deformed in accordance with the shape of the receiving space 313 and is smoothly received therein and an effect in that the waste liquid Q′ is efficiently permeated in the base material 5 and is efficiently absorbed in the water absorbing resin 4 can be obtained at the same time. In addition, since the absorbing portion 34 as described above uses a cellulose, that is, a nature-derived material, a support property of the water absorbing resin 4 by the base material 5 is excellent, and an effect to contribute to the reduction of environmental load can also be obtained.

Although not particularly limited, the average length of the fibers contained in the base material 5 is preferably 0.1 to 7.0 mm, more preferably 0.1 to 5.0 mm, and further preferably 0.2 to 3.0 mm.

Although not particularly limited, the average diameter of the fibers is preferably 0.05 to 2.00 mm and more preferably 0.10 to 1.00 mm.

Although not particularly limited, the average aspect ratio, that is, the ratio of the average length to the average diameter, of the fibers is preferably 10 to 1,000 and more preferably 15 to 500.

In addition, the average length and the average diameter of the fibers are average values of the lengths and the diameters, respectively, of at least 100 fibers.

When the average values are in the ranges described above, the support of the water absorbing resin 4, the retention of the waste liquid Q′ by the base material 5, and the transportation of the waste liquid Q′ to the water absorbing resin 4 can be more preferably performed.

In addition, the fibers contained in the small pieces 2 are not limited to those forming the base material 5, and fibers entangled with each other may also be used.

### 1.2.4.2 Water Absorbing Resin

As shown in FIGS. 2 and 3, the water absorbing resin 4 contained in the small piece 2 is supported by the base material 5. In the example shown in the drawings, the water absorbing resin 4 is supported only by one side surface 5a of the base material 5. In addition, although not shown in the drawings, the water absorbing resin 4 may be supported only by the other side surface 5b of the base material 5 or by the two side surfaces thereof. As described above, the small piece 2 is formed of the base material 5 which supports the water absorbing resin 4.

In addition, as shown in FIG. 3, the water absorbing resin 4 may partially or entirely intrude in the base material 5 from the one side surface 5a thereof. That is, the water absorbing resin 4 may be partially impregnated in the base material 5. Accordingly, a support force of the base material 5 for the water absorbing resin 4 can be increased, and the water absorbing resin 4 is suppressed from falling from the base material 5. As a result, the absorbing portion 34 formed as the aggregate of the small pieces 2 is able to have excellent absorbing characteristics of the waste liquid Q′ for a long time. Furthermore, the water absorbing resin 4 is suppressed from being unevenly distributed in the receiving space 313.

Furthermore, the small piece 2 may include a plurality of base materials 5 and the water absorbing resin 4 provided between the base materials 5. Since the water absorbing resin 4 is provided between the base materials 5, the water absorbing resin 4 is suppressed from falling from the small piece 2.

The water absorbing resin 4 is a super absorbent polymer (SAP) having a water absorbing property. The water absorption indicates a function to have a hydrophilic property and to retain a liquid, such as the ink Q or the waste liquid Q′ thereof. The water absorbing resin 4 may be gelled after water absorption.

In particular, as the water absorbing resin 4 according to this embodiment, an anionic water absorbing resin is preferably contained. The anionic water absorbing resin is a resin in which when moisture in a liquid is absorbed, its hydrophilic group is dissociated, and an anionic group is generated. In the anionic water absorbing resin as described above, although long polymer chains are densely entangled with each other under dry conditions, when absorbing moisture in a liquid once, the hydrophilic group tends to be dissolved in water, and the polymer chains start to be disentangled. Accordingly, a large amount of the liquid can be absorbed.

On the other hand, depending on the case in which a solute contained in the liquid is an electrolyte or a non-electrolyte, the anionic water absorbing resin shows different absorbing characteristics. For example, when the solute contained in the liquid is a non-electrolyte, regardless of the concentration of the non-electrolyte, an absorption amount of the liquid shows a relatively high value. Hence, for a pigment ink which is a liquid containing a non-electrolyte, regardless of the concentration of the non-electrolyte, the anionic water absorbing resin shows relatively good absorbing characteristics.

On the other hand, for a liquid containing an electrolyte, as the concentration of the electrolyte is increased, the absorption amount of the liquid by the anionic water absorbing resin tends to decrease. Hence, for a dye ink which is a liquid containing an electrolyte, the anionic water absorbing resin tends to show insufficient absorbing characteristics.

Although the anionic water absorbing resin is not particularly limited as long as being a rein having an anionic group upon absorption of water, for example, there may be mentioned a carboxymethyl cellulose, a poly(acrylic acid), a polyacrylamide, a starch-acrylic acid graft copolymer, a hydrolysate of a starch-acrylonitrile graft copolymer, a vinyl acetate-acrylic acid ester copolymer, a copolymer of isobutylene and maleic acid, a hydrolysate of an acrylonitrile copolymer or an acrylamide copolymer, a polyethylene oxide, a polysulfonic acid-based compound, a polyglutamic acid, or a salt, a modified compound, or a cross-linked compound of those mentioned above.

The anionic water absorbing resin preferably a resin having a functional group on its side chain. As the functional group, for example, there may be mentioned an acid group, a carboxy group, a hydroxy group, an epoxy group, or an amino group. In particular, a resin having an acid group on its side chain is preferable, and a resin having a carboxy group on its side chain is more preferable.

As a carboxy group-containing unit forming a side chain, for example, there may be mentioned a unit derived from acrylic acid, methacrylic acid, itaconic acid, maleic acid, crotonic acid, fumaric acid, sorbic acid, cinnamic acid, or a monomer, such as an anhydride or a salt, of each of those mentioned above.

In the anionic water absorbing resin having an acid group on its side chain, among the acid groups contained in the anionic water absorbing resin, the rate of an acid group which forms a salt by neutralization is preferably 30 to 100 percent by mole, more preferably 50 to 95 percent by mole, further preferably 60 to 90 percent by mole, and even further preferably 70 to 80 percent by mole. Accordingly, the anionic water absorbing resin is made to have excellent water absorbing characteristics of the waste liquid Q′.

As the type of neutralized salt, for example, there may be mentioned an alkali metal salt, such as a sodium salt, a potassium salt, or a lithium salt, or a salt of a nitrogen-containing basic compound, such as ammonium, and among those mentioned above, a sodium salt is preferable. Accordingly, the anionic water absorbing resin is able to have excellent absorbing characteristics of the waste liquid Q′.

The anionic water absorbing resin having an acid group on its side chain is preferable since when the waste liquid Q′ is absorbed, electrostatic repulsion occurs between the acid groups, and an absorbing rate is increased. In addition, when the acid group is neutralized, by the osmotic pressure, the waste liquid is likely to be absorbed in the anionic water absorbing resin.

The anionic water absorbing resin may have a constituent unit containing no acid group on its side chain. As the constituent unit described above, for example, there may be mentioned a hydrophilic constituent unit, a hydrophobic constituent unit, or a constituent unit used as a polymerizable cross-linking agent.

As the hydrophilic constituent unit described above, for example, there may be mentioned a constituent unit derived from a nonionic compound, such as acrylamide, methacrylamide, N-ethyl (meth)acrylamide, N-n-propyl (meth)acrylamide, N-isopropyl (meth)acrylamide, N,N-dimethyl (meth)acrylamide, 2-hydroxyethyl (meth)acrylate, 2-hydroxypropyl (meth)acrylate, a methoxypolyethylene glycol (meth)acrylate, a polyethylene glycol mono(meth)acrylate, N-vinylpyrrolidone, N-acryloylpiperidine, or N-acryloylpyrrolidine.

As the hydrophobic constituent unit described above, for example, there may be mentioned a constituent unit derived from a compound, such as (meth)acrylonitrile, styrene, vinyl chloride, butadiene, isobutene, ethylene, propylene, stearyl (meth)acrylate, or lauryl (meth)acrylate.

As the constituent unit used as a polymerizable cross-linking agent, for example, there may be mentioned a constituent unit derived from diethylene glycol diacrylate, N,N-methylene bisacrylamide, a polyethylene glycol diacrylate, a polypropylene glycol diacrylate, trimethylolpropane diallyl ether, trimethylolpropane triacrylate, allyl glycidyl ether, pentaerythritol triallyl ether, pentaerythritol diacrylate monostearate, bisphenol diacrylate, isocyanuric acid diacrylate, tetraallyl oxyethane, or diallyl oxyacetic acid salt.

The water absorbing resin 4 preferably includes a polyacrylic acid salt copolymer or a polyacrylic acid cross-linked polymer. Accordingly, for example, the absorption performance for the waste liquid QT may be improved, and/or the production cost may be reduced.

As the polyacrylic acid cross-linked polymer, the rate of a constituent unit having a carboxy group occupied in the total constituent units forming the molecular chain is preferably 50 percent by mole or more, more preferably 80 percent by mole or more, and further preferably 90 percent by mole or more. When the rate of the constituent unit containing a carboxy group is excessively low, it may be difficult to obtain sufficiently excellent absorbing characteristics of the waste liquid Q′ in some cases.

The carboxy group in the polyacrylic acid cross-linked polymer is preferably partially neutralized to form a salt. The rate of neutralized groups occupied in all the carboxy groups of the polyacrylic acid cross-linked polymer is preferably 30 to 99 percent by mole, more preferably 50 to 99 percent by mole, and further preferably 70 to 99 percent by mole.

In addition, the water absorbing resin 4 may have the structure cross-linked by a cross-linking agent other than the polymerizable cross-linking agent described above.

When the water absorbing resin 4 is a resin having an acid group, as the cross-linking agent, for example, a compound having a plurality of functional groups which react with the acid group is preferably used. When the water absorbing resin 4 is a resin having at least one functional group which reacts with the acid group, as the cross-linking agent, a compound having a plurality of functional groups which react with the acid group in its molecule is preferably used.

As the cross-linking agent having a plurality of functional groups which react with the acid group, for example, there may be mentioned a glycidyl ether compound, such as ethylene glycol glycidyl ether, trimethylolpropane triglycidyl ether, a (poly)glycerin polyglycidyl ether, a diglycerin polyglycidyl ether, or propylene glycol diglycidyl ether; a polyvalent alcohol, such as a (poly)glycerin, a (poly)ethylene glycol, propylene glycol, 1,3-propanediol, a polyoxyethylene glycol, triethylene glycol, tetraethylene glycol, diethanolamine, or triethanolamine; or a polyamine, such as ethylenediamine, diethylenediamine, a polyethyleneimine, or hexamethylenediamine. In addition, since polyvalent ions of zinc, calcium, magnesium, aluminum, or the like react with the acid group of the water absorbing resin 4 and function as a cross-linking agent, those ions mentioned above may be preferably used.

Although the water absorbing resin 4 may have any shapes, such as flakes, needles, fibers, or particles, most of the resin preferably has particle shapes. When the water absorbing resin 4 has particle shapes, the permeability of the waste liquid Q′ can be easily secured. In addition, the water absorbing resin 4 can be preferably supported by the base material 5. In addition, the particle shape indicates that the aspect ratio, that is, the ratio of the minimum length to the maximum length, is 0.3 to 1.0. The average particle diameter of the particles is preferably 50 to 800 μm, more preferably 100 to 600 μm, and further preferably 200 to 500 μm.

In addition, as the average particle diameter of the particles, for example, a volume average particle size MVD (mean volume diameter) measured, for example, by a laser diffraction particle size measurement device may be used. This particle size MVD may be obtained from a particle size distribution measured on a volume basis by a particle size distribution measurement device, that is, a laser diffraction particle size measurement device, using a laser diffraction/scattering method as a measurement principle.

When the average particle diameter of the water absorbing resin 4 and the average length of the fibers are represented by D [μm] and L [μm], respectively, 0.15≤L/D≤467 is preferably satisfied, 0.25≤L/D≤333 is more preferably satisfied, and 2≤L/D≤200 is further preferably satisfied.

A mass ratio of the water absorbing resin 4 with respect to the base material 5 is preferably 0.15 to 1.75, more preferably 0.20 to 1.50, and further preferably 0.25 to 1.20. Accordingly, the permeability of the waste liquid Q′ in the absorbing portion 34 and the absorbing characteristics of the waste liquid Q′ by the water absorbing resin 4 can be satisfied at the same time.

In addition, when the mass ratio of the water absorbing resin 4 is lower than the lower limit described above, the absorption amount by the water absorbing resin 4 may be unfavorably insufficient in some cases. On the other hand, when the mass ratio of the water absorbing resin 4 is over the upper limit described above, the water absorbing resin 4 is relatively excessive, and by a swelled water absorbing resin 4, the permeability of the waste liquid Q′ in the base material 5 may be disturbed in some cases.

The absorbing portion 34 may also contain various additives other than the base material 5 and the water absorbing resin 4. As the additives, for example, there may be mentioned a surfactant, a lubricant, a defoaming agent, a filler, a blocking inhibitor, an ultraviolet absorbent, a colorant, such as a pigment or a dye, a flame retardant, and/or a flow improver.

Among those additives mentioned above, as the flame retardant, for example, there may be mentioned a halogen-based flame retardant, a phosphorous-based flame retardant, a nitrogen compound-based flame retardant, a silicone-based flame retardant, or an inorganic-based flame retardant.

### 1.2.5 Metal Ion-Concentration Decrease Portion

The metal ion-concentration decrease portion 35 is provided between the pipe 36 and the discharge portion 33. The metal ion-concentration decrease portion 35 captures metal ions contained in the waste liquid Q′. As described above, the present inventor found that the metal ions contained in the dye ink decreases the absorption amount in the absorbing portion 34. Hence, when the metal ion-concentration decrease portion 35 is provided, the metal ion concentration in the waste liquid Q′ transported from the pipe 36 to the discharge portion 33 can be decreased. A relatively large amount of metal ions is contained in a dye ink than that in a pigment ink. When a large amount of the metal ions as described above is supplied to the absorbing portion 34, the absorption amount of the waste liquid Q′, in particular, the absorption amount of moisture, in the absorbing portion 34 is disadvantageously decreased in some cases.

Hence, in this embodiment, the liquid absorption system 100 is configured such that before the waste liquid Q′ comes in contact with the absorbing portion 34, the waste liquid Q′ passes through the metal ion-concentration decrease portion 35. In particular, the metal ion-concentration decrease portion 35 according to this embodiment is provided between the pipe 36 and the discharge portion 33. Since the metal ion-concentration decrease portion 35 is provided at the position as described above, before the waste liquid Q′ comes in contact with the absorbing portion 34, the metal ions in the waste liquid Q′ can be decreased in advance. Hence, even when the waste liquid Q′ passing through the metal ion-concentration decrease portion 35 is supplied to the absorbing portion 34, the absorption amount, in particular, the absorption amount of moisture, in the absorbing portion 34 can be suppressed from being decreased due to the metal ions. In addition, since the metal ion-concentration decrease portion 35 is provided in the receiving space 313 of the container 31, for example, the metal ion-concentration decrease portion 35 can be handled together with the container 31. Hence, for example, a metal ion-concentration decrease portion 35 which is excessively used over the use limit can be easily removed from the image forming apparatus 200.

In addition, although not shown in the drawings, the metal ion-concentration decrease portion 35 may also function as the discharge portion 33. That is, the metal ion-concentration decrease portion 35 is provided at the discharge portion 33 and may have the function thereof. In this case, as is the case described above, the absorption amount in the absorbing portion 34 can also be suppressed from being decreased.

As the metal ion-concentration decrease portion 35, any member including a medium capable of decreasing the metal ion concentration in the waste liquid Q′ may be used. As a concentration decrease medium 354 which will be described below, for example, there may be mentioned a cation exchange resin, such as a strong acid cation exchange resin or a weak acid cation exchange resin, or an ion capture agent, such as active carbon, zeolite, silica gel, alumina gel, silica alumina gel, activated white earth, molecular sieve, molecular sieving carbon, an aromatic-based synthetic adsorbent, or a methacrylic acid ester-based synthetic adsorbent, and those compounds mentioned above may be used alone, or at least two types thereof may be used in combination.

In particular, when the water absorbing resin 4, which is a polymer absorbent, includes an anionic water absorbing resin, the metal ion-concentration decrease portion 35 preferably contains a cation exchange resin or an ion capture agent.

Since the cation exchange resin is used, metal ions disturbing the absorption of the waste liquid Q′ in the anionic water absorbing resin are ion-exchanged in the metal ion-concentration decrease portion 35. Hence, even when a dye ink containing a relatively large amount of metal ions is recovered as the waste liquid Q′, the concentration of the metal ions therein can be decreased in the metal ion-concentration decrease portion 35. As a result, in the absorbing portion 34, the absorption is not likely to be disturbed by the metal ions, and a sufficient amount of the waste liquid Q′ may be absorbed in the absorbing portion 34.

In addition, since the ion capture agent is used, the metal ions are captured in the metal ion-concentration decrease portion 35. Hence, the absorption is not likely to be disturbed by the metal ions, and a sufficient amount of the waste liquid Q′ may be absorbed in the absorbing portion 34.

Although the metal ions, the concentration of which can be decreased in the metal ion-concentration decrease portion 35, are not particularly limited, and all types of metal ions may be mentioned, for example, there may be mentioned potassium ions, sodium ions, calcium ions, or magnesium ions. In addition, the metal ion-concentration decrease portion 35 may also have a function to decrease the concentration of ions other than the metal ions.

FIG. 4 is an enlarged cross-sectional view of the metal ion-concentration decrease portion 35 shown in FIG. 1.

The metal ion-concentration decrease portion 35 shown in FIG. 4 includes a decrease portion container 352 and the concentration decrease medium 354 received in the decrease portion container 352.

The decrease portion container 352 includes a pipe hole 356 to which the pipe 36 is coupled and a discharge hole 358 to which the discharge portion 33 is fitted. The pipe hole 356 is an inlet of the decrease portion container 352 for the waste liquid Q′, and the discharge hole 358 is an outlet for the waste liquid Q′. The decrease portion container 352 has a liquid-tight property and temporarily stores the waste liquid Q′ transported through the pipe 36. In this step, the waste liquid Q′ comes in contact with the concentration decrease medium 354 received in the decrease portion container 352. The discharge hole 358 is located at a side of the decrease portion container 352 opposite to the pipe hole 356. Hence, the waste liquid Q′ in contact with the concentration decrease medium 354 is allowed to drip in the receiving space 313 of the container 31 through the discharge portion 33. According to the structure described above, the contact opportunity between the waste liquid Q′ and the concentration decrease medium 354 can be sufficiently secured, and the metal ions in the waste liquid Q′ are sufficiently brought into contact with the concentration decrease medium 354 and can be captured.

Although the form of the concentration decrease medium 354 is not particularly limited, besides the particles shown in FIG. 4, for example, fibers, clumps, or cloths may be mentioned. Among those mentioned above, when the medium is in the form of particles or fibers, the shape followability thereof is high, and hence, a filling rate of the concentration decrease medium 354 in the decrease portion container 352 can be easily increased. As a result, even when a flow rate of the waste liquid Q′ passing through the metal ion-concentration decrease portion 35 is high, the metal ion concentration can be decreased. In addition, when a concentration decrease medium 354 in the form of cloths is used together with a concentration decrease medium 354 in the form of particles or fibers, the latter medium is suppressed from flowing out of the decrease portion container 352. In addition, the concentration decrease medium 354 in the form of fibers indicates, for example, an ion exchange resin in the form of chopped fibers. In addition, the concentration decrease medium 354 in the form of cloths indicates, for example, an ion exchange resin in the form of non-woven cloths.

In addition, the structure of the metal ion-concentration decrease portion 35 is not limited to that described above. For example, the structure in which the decrease portion container 352 is omitted, and the concentration decrease medium 354 is disposed at a part of the pipe 36 may also be used. In addition, in the decrease portion container 352, arbitrary members, materials, and the like other than the concentration decrease medium 354 may also be received.

In addition, as the metal ion-concentration decrease portion 35, a member having the following performance is more preferably used. In particular, the metal ion concentration can be quantified by the electric conductivity of the liquid, and in general, as the electric conductivity is lower, the metal ion concentration can be regarded to be lower.

The liquid through the metal ion-concentration decrease portion 35, that is, the waste liquid Q′ after passing through the metal ion-concentration decrease portion 35, preferably has an electric conductivity of less than 1,000 μS/cm and more preferably has an electric conductivity of 900 μS/cm or less. When the electric conductivity is as described above, the metal ion concentration can be regarded to be sufficiently low. In addition, when the waste liquid Q′ has the electric conductivity as described above, even when this waste liquid Q′ comes in contact with the absorbing portion 34, in particular, the absorption amount can be suppressed from being significantly decreased. Hence, a metal ion-concentration decrease portion 35 having the concentration decreasing capability as described above is particularly useful.

The electric conductivity of the waste liquid Q′ can be measured at a liquid temperature of 25° C. using a table type pH meter F-55 manufactured by Horiba, Ltd.

From an angle different from that described above, when the electric conductivity of the waste liquid Q′ before passing through the metal ion-concentration decrease portion 35 is represented by XB [μS/cm], and the electric conductivity of the waste liquid Q′ after passing through the metal ion-concentration decrease portion 35 is represented by XA [μS/cm], XA/XB is preferably 0.004 to 0.95 and more preferably 0.030 to 0.80. A metal ion-concentration decrease portion 35 which satisfies the relationship as described above has a sufficient metal ion absorbing capability.

As described above, the liquid absorption system 100 according to this embodiment includes the pipe 36 which transports the waste liquid Q′ which is a liquid containing metal ions; the discharge portion 33 which discharges the waste liquid Q′ transported through the pipe 36; the container 31 which recovers the waste liquid Q′ discharged from the discharge portion 33; the absorbing portion 34 which is received in the container 31 and which includes the water absorbing resin 4, which is a polymer absorbent, absorbing the waste liquid Q′; and the metal ion-concentration decrease portion 35 which decreases the concentration of the metal ions contained in the waste liquid Q′. In addition, the metal ion-concentration decrease portion 35 is provided at a position at which the metal ion-concentration decrease portion 35 comes in contact with the waste liquid Q′ before the waste liquid Q′ comes in contact with the absorbing portion 34.

According to the structure as described above, since the metal ions in the waste liquid Q′ are captured by the metal ion-concentration decrease portion 35, and the concentration thereof is decreased, the absorbing portion 34 is prevented from coming in contact with a large amount of metal ions. Accordingly, the absorption amount of the waste liquid Q′ in the absorbing portion 34 can be prevented from being decreased by the metal ions, and regardless of the composition of the waste liquid Q′, a sufficient absorption amount can be secured. As a result, a liquid absorption system 100 having an excellent absorbing capability of the waste liquid Q′ by a polymer absorbent can be realized. In particular, in the case of a liquid, such as a dye ink, containing a relatively large amount of metal ions besides water as a primary component, the effect described above is significant.

### 1.3. Method for Manufacturing Liquid Absorption System

Next, a method for manufacturing the liquid absorption system 100 will be described.

FIGS. 5 to 7 are views each illustrating a method for manufacturing the absorbing portion 34 of the liquid absorption system 100 shown in FIG. 1.

First, as shown in FIG. 5, a sheet-shaped sheet member 3, such as old paper, is disposed on a stage 101. On the sheet member 3 thus disposed, water or an aqueous resin is applied and spread.

Next, the water absorbing resin 4 is applied to one side surface 3a of the sheet member 3 with a mesh member 102 interposed therebetween. The mesh member 102 has meshes 102a. Of the water absorbing resin 4, particles each having a larger size than the mesh 102a are trapped by the mesh member 102, and particles each having a smaller size than the mesh 102a are applied on the surface 3a of the sheet member 3 through the meshes 102a. Hence, by a tack force obtained by water absorption or an adhesive force by a water soluble resin, the water absorbing resin 4 is fixed and supported on the surface 3a of the sheet member 3.

As described above, since the mesh member 102 is used, the uniformity of particle diameters of the water absorbing resin 4 can be increased. Hence, the absorbing characteristics are suppressed from fluctuating depending on the position of the sheet member 3.

The maximum width of the mesh 102a is preferably 0.06 to 0.15 mm and more preferably 0.08 to 0.12 mm. Accordingly, the particle diameters of the water absorbing resin 4 to be applied to the sheet member 3 can be set in the numerical range described above.

Next, as shown in FIG. 6, the sheet member 3 to which the water absorbing resin 4 is adhered is disposed between a pair of heating blocks 103. Subsequently, the pair of heating blocks 103 is heated, and at the same time, the pressure is applied in a direction such that the two heating blocks 103 come close to each other; hence, the sheet member 3 is pressurized in a thickness direction. Accordingly, the water absorbing resin 4 is softened and is then allowed to intrude in the sheet member 3 by the pressure application.

A pressure to be applied in this step is preferably 0.1 to 1.0 kg/cm² and more preferably 0.2 to 0.8 kg/cm². A heating temperature in this step is preferably 80° C. to 160° C. and more preferably 100° C. to 120° C.

Next, the sheet member 3 is formed into small parts by finely cutting/crushing/pulverizing using scissors, a cutter, a mill, a shredder, or the like or by tearing with hands. Accordingly, a plurality of small pieces 2 is obtained, and the absorbing portion 34 formed from an aggregate of the small pieces 2 is obtained.

In addition, after a desired amount of the small pieces 2 thus obtained is measured, the small pieces 2 are disentangled, for example, with hands to adjust the bulk density and are then received in the container 31. Accordingly, as shown in FIG. 7, the absorbing portion 34 is received in the container 31.

### 2. First Modified Example

Next, a liquid absorption system according to a first modified example will be described.

In the liquid absorption system 100 according to the first embodiment described above, the absorbing portion 34 is formed of the aggregate of the small pieces 2. On the other hand, in a liquid absorption system 100 according to the first modified example, the absorbing portion 34 is formed of a resin base material (not shown) and the water absorbing resin 4 supported by the resin base material.

As a constituent material of the resin base material, for example, there may be mentioned a resin material, such as an urethane foam, a foamed polystyrene, a foamed polyethylene, a foamed polypropylene, or a vinyl lactam-based cross-linked polymer.

The shape of the resin base material is not particularly limited and may be clumps, small pieces, particles, or shapes others than those mentioned above.

A mass ratio of the water absorbing resin 4 to the resin base material is preferably 0.15 to 1.75, more preferably 0.20 to 1.50, and further preferably 0.25 to 1.20. Accordingly, the permeability of the waste liquid Q′ in the absorbing portion 34 and the absorbing characteristics of the waste liquid Q′ by the water absorbing resin 4 can be obtained at the same time.

In addition, when the mass ratio of the water absorbing resin 4 is lower than the lower limit described above, the absorption amount by the water absorbing resin 4 may be insufficient in some cases. On the other hand, when the mass ratio of the water absorbing resin 4 is over the upper limit described above, the water absorbing resin 4 is relatively excessive, and the permeation of the waste liquid Q′ in the resin base material may be disturbed by a swelled water absorbing resin 4 in some cases.

In the first modified example as described above, an effect similar to that in the first embodiment may also be obtained.

### 3. Second Modified Example

FIG. 8 is a partially vertical cross-sectional view of a liquid absorption system 100A according to a second modified example.

Hereinafter, although the second modified example will be described, in the following description, points different from the first embodiment will be mainly described, and description of matters similar to those of the first embodiment will be omitted. In addition, in FIG. 8, a constituent element similar to that of the first embodiment will be designated by the same reference numeral.

The liquid absorption system 100A according to the second modified example is similar to the liquid absorption system 100 according to the first embodiment except for the position of a metal ion-concentration decrease portion 35A.

In the liquid absorption system 100A shown in FIG. 8, the metal ion-concentration decrease portion 35A is provided on the way of the pipe 36.

According to the structure as described above, before coming in contact with the absorbing portion 34, the waste liquid Q′ passes through the metal ion-concentration decrease portion 35A. Hence, even when the waste liquid Q′ is supplied to the absorbing portion 34, the absorption amount in the absorbing portion 34 is suppressed from being decreased.

In addition, in FIG. 8, the metal ion-concentration decrease portion 35A is provided outside of the container 31. In the case described above, without receiving any restriction of the volume of the container 31, the metal ion-concentration decrease portion 35A can be easily formed to have a larger size. Accordingly, a captured amount of metal ions in the metal ion-concentration decrease portion 35a can be increased, and the metal ion-concentration decrease portion 35A can be used for a long time without performing an exchange operation thereof. In addition, exchange frequency of the metal ion-concentration decrease portion 35a can be reduced. Furthermore, since the container 31 is not required to receive the metal ion-concentration decrease portion 35A, corresponding to the volume thereof, the size of the container 31 can also be reduced.

In addition, the metal ion-concentration decrease portion 35A shown in FIG. 8 may be configured to be detachable to the pipe 36. Accordingly, the exchange operation of the metal ion-concentration decrease portion 35A can be easily performed. In addition, although being provided on the way of the pipe 36, the metal ion-concentration decrease portion 35A shown in FIG. 8 may be provided at an upstream end portion or a downstream end portion of the pipe 36.

In the second modified example described above, an effect similar to that of the first embodiment may also be obtained.

### 4. Third Modified Example

FIG. 9 is a partially vertical cross-sectional view showing a liquid absorption system 100B according to a third modified example.

Hereinafter, although the third modified example will be described, in the following description, points different from the first embodiment will be mainly described, and description of matters similar to those of the first embodiment will be omitted. In addition, in FIG. 9, a constituent element similar to that of the first embodiment will be designated by the same reference numeral.

The liquid absorption system 100B according to the third modified example is similar to the liquid absorption system 100 according to the first embodiment except for the positions of the metal ion-concentration decrease portion 35, the discharge portion 33, and the like.

In the liquid absorption system 100 according to the first embodiment described above, the metal ion-concentration decrease portion 35 is located in the receiving space 313 of the container 31. On the other hand, in the liquid absorption system 100B according to the third modified example, the metal ion-concentration decrease portion 35 is provided outside of the container 31. In addition, besides the metal ion-concentration decrease portion 35, the pipe 36 and the discharge portion 33 are also provided outside of the container 31.

In addition, a lid 32 shown in FIG. 9 has a waste liquid passing opening 322 penetrating along the Z axis. In addition, the positions of the discharge portion 33 and the waste liquid passing opening 322 are set so that a waste liquid Q′ which drips from the discharge portion 33 passes through the waste liquid passing opening 322.

According to the structure as described above, since the container 31 and the pipe 36 can be separated from each other, in particular, an operation of exchanging the container 31 receiving the absorbing portion 34 can be easily performed. In addition, as is the case of the above second modified example, since the metal ion-concentration decrease portion 35 can be provided outside of the container 31, without receiving any restriction of the volume of the container 31, the metal ion-concentration decrease portion 35 can be formed to have a larger size. Hence, the captured amount of the metal ions in the metal ion-concentration decrease portion 35 can be increased.

In the third modified example described above, an effect similar to that of the first embodiment may also be obtained.

### 5. Second Embodiment

Next, a liquid absorption unit according to a second embodiment will be described.

FIG. 10 is a partially vertical cross-sectional view showing the liquid absorption unit according to the second embodiment. FIG. 11 is a horizontal cross-sectional view of the liquid absorption unit shown in FIG. 10.

Hereinafter, although the second embodiment will be described, in the following description, points different from the first embodiment will be mainly described, and description of matters similar to those of the first embodiment will be omitted. In addition, in FIGS. 10 and 11, a constituent element similar to that of the first embodiment will be designated by the same reference numeral.

A liquid absorption unit 1000 according to the second embodiment is similar to the liquid absorption system 100 according to the first embodiment except for the following structure.

In the liquid absorption systems according to the first embodiment and its modified examples, the metal ion-concentration decrease portion is provided at the pipe 36 or the discharge portion 33 or between the pipe 36 and the discharge portion 33. On the other hand, in the liquid absorption unit 1000 according to this embodiment, a metal ion-concentration decrease portion 35C is separated from the pipe 36 and the discharge portion 33 and is disposed in the receiving space 313 of the container 31. In particular, the metal ion-concentration decrease portion 35C shown in FIG. 10 is disposed in the receiving space 313 together with the absorbing portion 34.

In addition, as shown in FIG. 10, the metal ion-concentration decrease portion 35C is provided right under an introduction portion 37. In addition, the structure of the introduction portion 37 is similar to that of the discharge portion 33 according to the first embodiment. In addition, in the horizontal cross-sectional view of FIG. 11, the absorbing portion 34 is provided to have an annular shape so as to surround the metal ion-concentration decrease portion 35C. Furthermore, as shown in FIG. 10, the absorbing portion 34 is also disposed at a lower side of the metal ion-concentration decrease portion 35C.

That is, the liquid absorption unit 1000 according to this embodiment includes the container 31 which recovers the waste liquid Q′, which is a liquid containing metal ions, introduced from the introduction portion 37 configured to introduce the waste liquid Q′; the absorbing portion 34 which is received in the container 31 and which includes the water absorbing resin 4, which is a polymer absorbent, absorbing the waste liquid Q′; and the metal ion-concentration decrease portion 35C which is received in the container 31 and which decreases the metal ions contained in the waste liquid Q′. In addition, the metal ion-concentration decrease portion 35C is provided at a position at which the metal ion-concentration decrease portion 35C comes in contact with the waste liquid Q′ before the waste liquid Q′ comes in contact with the absorbing portion 34.

According to the structure as described above, the waste liquid Q′ introduced from the introduction portion 37 first comes in contact with the metal ion-concentration decrease portion 35C located at a position right under the introduction portion 37 and then comes in contact with the absorbing portion 34. That is, before coming in contact with the absorbing portion 34, the waste liquid Q′ comes in contact with the metal ion-concentration decrease portion 35C. Accordingly, in the metal ion-concentration decrease portion 35C, the metal ion concentration in the waste liquid Q′ can be decreased. As a result, even when the waste liquid Q′ passing through the metal ion-concentration decrease portion 35C is supplied to the absorbing portion 34, the absorption amount of the waste liquid Q′, in particular, the absorption amount of moisture, in the absorbing portion 34 can be suppressed from being decreased.

In addition, according to the liquid absorption unit 1000, the absorbing portion 34 and the metal ion-concentration decrease portion 35C are both received in the container 31, and the structure is relatively simple. Hence, in terms of production easiness and production cost, the liquid absorption unit 1000 is also useful.

The introduction portion 37 introduces the waste liquid Q′ into the receiving space 313 of the container 31. As is the discharge portion 33 according to the first embodiment, the introduction portion 37 as described above is provided at a downstream side end portion of the pipe 36 which extends from the outside of the container 31 to the receiving space 313 through the insertion hole 316 provided in the side wall portion 312 of the container 31.

At the lower side of the metal ion-concentration decrease portion 35C shown in FIG. 10, as described above, the absorbing portion 34 is provided. That is, the metal ion-concentration decrease portion 35C shown in FIG. 10 is disposed above the absorbing portion 34 in a vertical direction.

According to the structure as described above, when the waste liquid Q′ introduced from the introduction portion 37 spontaneously falls, the waste liquid Q′ first comes in contact with the metal ion-concentration decrease portion 35C and is then likely to be transferred to the absorbing portion 34. Hence, a flow in which the waste liquid Q′ continuously introduced is transferred to the absorbing portion 34 through the metal ion-concentration decrease portion 35C is likely to be formed. As a result, the waste liquid Q′ to be introduced is suppressed from staying in the metal ion-concentration decrease portion 35C.

In this embodiment, as shown in FIG. 11, the metal ion-concentration decrease portion 35C is provided at an introduction position 374 to which the waste liquid Q′, which is a liquid, is introduced from the introduction portion 37. In particular, the introduction position 374 is regarded as a range to which the waste liquid Q′ reaches at a moment at which the waste liquid Q′ introduced from the introduction portion 37 scatters or intrudes into gaps upon collision with the metal ion-concentration decrease portion 35C. Hence, for example, as shown in FIGS. 10 and 11, the introduction position 374 indicates a predetermined range extending in an X-Y plan right under the introduction portion 37 and also indicates a predetermined depth range extending below from the above range in the vertical direction.

Since the metal ion-concentration decrease portion 35C is disposed at the introduction position 374 as described above, before the waste liquid Q′ introduced from the introduction portion 37 comes in contact with the absorbing portion 34, in particular, the probability of the waste liquid Q′ to come in contact with the metal ion-concentration decrease portion 35C can be increased.

In addition, as shown in FIG. 11, the absorbing portion 34 is provided at a side wall portion 312 side of the container 31 than the introduction position 374. Furthermore, as shown in FIG. 10, the absorbing portion 34 is provided at a bottom portion 311 side of the container 31 than the introduction position 374.

According to the structure as described above, when the waste liquid Q′ which comes in contact with the metal ion-concentration decrease portion 35C is diffused in all directions, for example, using a capillary phenomenon as a driving force, the waste liquid Q′ thus diffused can be received in the absorbing portion 34. Accordingly, the flow of the waste liquid Q′ from the metal ion-concentration decrease portion 35C to the absorbing portion 34 can be more reliably formed. As a result, the absorption amount in the absorbing portion 34 can be maximally increased.

In addition, the positional relationship between the metal ion-concentration decrease portion 35C and the absorbing portion 34 is not limited to that described above. For example, the metal ion-concentration decrease portion 35C may penetrate the absorbing portion 34 along the vertical axis. In addition, the metal ion-concentration decrease portion 35C may partially reach the side wall portion 312.

In addition, when viewed in plan from the above, the metal ion-concentration decrease portion 35C is not limited to have a square shape shown in FIG. 11 and may have a round shape, a polygonal shape, or a shape other than those mentioned above.

Furthermore, the lengths of the metal ion-concentration decrease portion 35C along the X axis and the Y axis each may be constant regardless of the position along the Z axis or may be changed in accordance with the position along the Z axis.

In addition, the number of the metal ion-concentration decrease portions 35C received in the container 31 is not limited to one shown in the drawing and may also be at least two.

Furthermore, the height of the upper surface of the metal ion-concentration decrease portion 35C and the height of the upper surface of the absorbing portion 34 are not necessarily the same as shown in FIG. 10 and may be different from each other.

In addition, although separated from each other as shown in FIG. 10, the introduction portion 37 and the metal ion-concentration decrease portion 35C may also be in contact with each other. In the latter case, the range of the metal ion-concentration decrease portion 35C in the X-Y plan can be decreased as compared to that in the former case. Hence, corresponding to the decrease in the range, the volume of the absorbing portion 34 can be increased.

For example, as is the case of the metal ion-concentration decrease portion 35 according to the first embodiment, the metal ion-concentration decrease portion 35C includes a concentration decrease medium. The concentration decrease medium is similar to the concentration decrease medium 354 of the first embodiment. In addition, as is the first embodiment, the form of the concentration decrease medium of the metal ion-concentration decrease portion 35C may be, for example, particles, fibers, clumps, cloths, or the like.

In this embodiment, the absorbing portion 34 is also formed of the aggregate of the small pieces 2 shown in FIGS. 2 and 3. As shown in FIGS. 2 and 3, the small pieces 2 each preferably include the base material 5 which contains cellulose fibers and the water absorbing resin 4, which is a polymer absorbent, supported by this base material 5.

According to the structure as described above, an effect in that when being received in the container 31, the absorbing portion 34 is deformed in accordance with the shape of the receiving space 313 and is smoothly received therein and an effect in that the waste liquid Q′ is efficiently permeated in the base material 5 and is efficiently absorbed by the water absorbing resin 4 can be obtained at the same time. In addition, since the absorbing portion 34 as described above is formed using a natural derived material, such as a cellulose, the support property of the water absorbing resin 4 by the base material 5 is excellent, and an effect to contribute to the reduction of environmental load may also be obtained.

In this embodiment, when the water absorbing resin 4, which is a polymer absorbent, includes an anionic water absorbing resin, the metal ion-concentration decrease portion 35C preferably contains a cation exchange resin or an ion capture agent.

By the use of the cation exchange resin, the metal ions which disturb the absorption of the waste liquid Q′ in the anionic water absorbing resin are ion-exchanged in the metal ion-concentration decrease portion 35C. Hence, even when a dye ink containing a relatively large amount of metal ions is recovered as the waste liquid Q′, the concentration of the metal ions can be decreased in the metal ion-concentration decrease portion 35C. As a result, in the absorbing portion 34, the disturbance of the absorption caused by the metal ions is not likely to be generated, and a sufficient amount of the waste liquid Q′ can be absorbed in the absorbing portion 34.

In addition, since the ion capture agent is used, the metal ions are captured in the metal ion-concentration decrease portion 35C. Hence, in the absorbing portion 34, the disturbance of the absorption caused by the metal ions is not likely to be generated, and a sufficient amount of the waste liquid Q′ can be absorbed in the absorbing portion 34.

Furthermore, as the metal ion-concentration decrease portion 35C, in more preferable, a member having the following performance is used. In particular, the metal ion concentration can be quantified by the electric conductivity of the liquid, and in general, as the electric conductivity is lower, the metal ion concentration can be regarded to be lower.

A liquid after coming in contact with the metal ion-concentration decrease portion 35C, that is, the waste liquid Q′ after passing through the metal ion-concentration decrease portion 35C, preferably has an electric conductivity of less than 1,000 μS/cm and more preferably 900 μS/cm or less. When the electric conductivity is as described above, the metal ion concentration of the waste liquid Q′ is regarded to be sufficiently low. In addition, when the waste liquid Q′ has the electric conductivity as described above, even when the waste liquid Q′ comes in contact with the absorbing portion 34, in particular, the absorption amount can be suppressed from being significantly decreased. Hence, a metal ion-concentration decrease portion 35C having the concentration decrease capability as described above is particularly useful.

In the second embodiment as described above, an effect similar to that of the first embodiment or its modified example may also be obtained.

### 6. Fourth Modified Example

FIG. 12 is a partially vertical cross-sectional view showing a liquid absorption unit 1000A according to a fourth modified example.

Hereinafter, although the fourth modified example will be described, in the following description, points different from the second embodiment will be mainly described, and description of matters similar to those of the second embodiment will be omitted. In addition, in FIG. 12, a constituent element similar to that of the second embodiment will be designated by the same reference numeral.

The liquid absorption unit 1000A according to the fourth modified example is similar to the liquid absorption unit 1000 according to the second embodiment except for the position of the introduction portion 37.

In the liquid absorption unit 1000 according to the second embodiment described above, the introduction portion 37 is located in the receiving space 313 of the container 31. On the other hand, in the liquid absorption unit 1000A according to the fourth modified example, the introduction portion 37 is provided outside of the container 31.

In addition, a lid 32 shown in FIG. 12 has a waste liquid passing opening 322 penetrating along the Z axis. In addition, the positions of the introduction portion 37 and the lid 32 are set so that a waste liquid Q′ which drips from the introduction portion 37 passes through the waste liquid passing opening 322.

According to the structure as described above, since the container 31 and the introduction portion 37 can be separated from each other, in particular, an exchange operation of the container 31 in which the absorbing portion 34 is received can be easily performed.

In the fourth modified example as described above, an effect similar to that of the second embodiment may also be obtained.

In addition, the image forming apparatus 200 according to this embodiment includes the liquid absorption system 100, 100A, or 100B described above or the liquid absorption unit 1000 or 1000A described above.

According to the image forming apparatus 200 as described above, for example, even when a dye ink containing a relatively large amount of metal ions is used, the absorption amount in the absorbing portion 34 is not likely to be decreased, and a sufficient amount of the waste liquid Q′ can be absorbed. Accordingly, since a practical absorption amount of the absorbing portion 34 can be increased, maintenance intervals can be increased, and as a result, an easy-to-use image forming apparatus 200 can be realized.

Heretofore, although the liquid absorption system, the liquid absorption unit, and the image forming apparatus have been described with reference to the embodiments using the drawings, the present disclosure is not limited thereto, and constituent elements forming the liquid absorption system, the liquid absorption unit, and the image forming apparatus each may be replaced with an arbitrary element having a sufficient function similar to that described above. In addition, an arbitrary constituent element may also be added to those described above.

In addition, the liquid absorption system and the liquid absorption unit of the present disclosure may be used to absorb, besides the waste ink liquid, any types of liquids.

Furthermore, the liquid absorption systems and the liquid absorption units according to the embodiments described above each may be used, for example, as an “ink leakage receiver” to absorb an ink which unintentionally leaks from an ink flow path of an image forming apparatus.

### EXAMPLES

Next, concrete examples of the present disclosure will be described.

### 7. Relationship Between Electric Conductivity and Absorption Performance of Evaluation Liquid

First, as a preliminary test, the relationship between the absorption performance of the absorbing portion and the electric conductivity of a liquid to be absorbed in the absorbing portion used for the liquid absorption system or the liquid absorption unit was evaluated.

In particular, first, as shown in Table 1, five types of evaluation liquids a to e having different electric conductivities were prepared. In addition, the evaluation liquids a to e were each a sodium chloride aqueous solution in which a sodium chloride concentration was adjusted so as to have the electric conductivity shown in Table 1. In addition, as water which dissolved sodium chloride, purified water having an electric conductivity of 1.0 μS/cm at a temperature of 25° C. was used.

Next, five beakers each having a volume of 100 cc were prepared, and 1 g of a water absorbing resin which was a polymer absorbent was received in each beaker. As the water absorbing resin, Sunfresh ST-500D, anionic water absorbing resin manufactured by Sanyo Chemical Industries, Ltd., was used. The water absorbing resin had particle shapes having a particle diameter of 350 μm.

Subsequently, the evaluation liquids a to e were received in the five beakers. In addition, the evaluation liquids a to e and the water absorbing resins in the beakers were stirred with spoons for 60 seconds. In this step, a stirring rate was set to 20 Hz.

After the stirring was performed, the beaker was placed upside down on non-woven cloth mesh and then left for 30 seconds. In this step, unabsorbed evaluation liquids a to e obtained through the non-woven cloth mesh were each collected in a different beaker and then weighed.

The amounts of the unabsorbed evaluation liquids a to e are shown in Table 1. The amounts of the unabsorbed evaluation liquids a to e were ranked with reference to the following evaluation criteria. In addition, “entire” in the following evaluation criteria indicates the entire amount of each of the evaluation liquids a to e in the beakers.

Evaluation Criteria

A: Amount of unabsorbed evaluation liquid is zero.
B: Amount of unabsorbed evaluation liquid is less than 25% of entire liquid.
C: Amount of unabsorbed evaluation liquid is 25% to less than 50% of entire liquid.
D: Amount of unabsorbed evaluation liquid is 50% or more of entire liquid.

Evaluation results are shown in Table 1.

TABLE 1

| | | EVALUATION RESULT | |
|---|---|---|---|
| | TEST | AMOUNT OF | |
| | CONDITION | UNABSORBED | |
| | ELECTRIC | EVALUATION | |
| | CONDUC- | LIQUID AFTER | EVALUATION |
| | TIVITY | 60 SECONDS | RANK |
| | μS/cm | cc | — |
| EVALUATION | 1 | 0 | A |
| LIQUID a | | | |
| EVALUATION | 500 | 17.83 | B |
| LIQUID b | | | |
| EVALUATION | 1000 | 39.65 | C |
| LIQUID c | | | |
| EVALUATION | 2000 | 47.7 | C |
| LIQUID d | | | |
| EVALUATION | 3000 | 58.36 | D |
| LIQUID e | | | |

As shown in Table 1, between the electric conductivity of the evaluation liquid and the amount of the unabsorbed evaluation liquid, a predetermined correlation was observed. In particular, it was found that when the electric conductivity is 1,000 μS/cm (1 mS/cm) or more, the amount of the unabsorbed evaluation liquid was increased, and especially, when the electric conductivity is 3,000 μs/cm (3 mS/cm) or more, a half of the entire liquid or more was not absorbed.

### 8. Formation of First Evaluation Model

### Example 1

In Example 1, an evaluation model was formed so as to imitate the metal ion-concentration decrease portion 35 shown in FIG. 9.

First, a column provided with a polyethylene-made perforated plate at the lowest position was prepared. As the column, a Mini-column M manufactured by Muromachi Chemical Co. was used, and as the perforated plate, a Perforated Plate M manufactured by Muromachi Chemical Co. was used. Next, an ion exchange resin was placed in the column and was vibrated. As a result, an evaluation model imitating the metal ion-concentration decrease portion 35 was obtained. In addition, as the ion exchange resin, a strong acid cation exchange resin, Muromac XSM-N525 manufactured by Muromachi Chemical Co. was used. In addition, the use amount of the ion exchange resin is as shown in Table 2.

Subsequently, an evaluation model was formed as described below so as to imitate the absorbing portion 34 and the container 31 shown in FIG. 9.

First, a plastic beaker having a volume of 100 cc was prepared. Next, 1 g of a water absorbing resin which was a polymer absorbent was placed in the beaker. As the water absorbing resin, Sunfresh ST-500D, an anionic water absorbing resin manufactured by Sanyo Chemical Industries, Ltd., was used. The water absorbing resin were particles each having a particle diameter of 350 μm. Accordingly, the evaluation model imitating the absorbing portion 34 and the container 31 was obtained.

Subsequently, an evaluation liquid was formed so as to imitate the waste liquid Q′.

First, purified water having an electric conductivity of 1.0 μS/cm at a temperature of 25° C. was prepared. Next, a reagent of sodium chloride was dissolved in the purified water to form a sodium chloride aqueous solution. Accordingly, the evaluation liquid imitating the waste liquid Q′ was obtained. In addition, the electric conductivity of the sodium chloride aqueous solution is as shown in Table 2.

### Example 2

Except for that an aqueous solution having a higher concentration of sodium chloride was used as the evaluation liquid, an evaluation model was obtained in a manner similar to that of Example 1.

### Example 3

Except for that as the ion exchange resin to be used for the metal ion-concentration decrease portion, an ion exchange resin of the evaluation model of Example 2 which was used in an evaluation test to be described later was used, an evaluation model was obtained in a manner similar to that of Example 2.

### Example 4

Except for that as the ion exchange resin to be used for the metal ion-concentration decrease portion, an ion exchange resin of the evaluation model of Example 3 which was used in the evaluation test to be described later was used, an evaluation model was obtained in a manner similar to that of Example 2.

### Example 5

Except for that as the ion exchange resin to be used for the metal ion-concentration decrease portion, an ion exchange resin of the evaluation model of Example 4 which was used in the evaluation test to be described later was used, an evaluation model was obtained in a manner similar to that of Example 2.

### Example 6

Except for that as the ion exchange resin to be used for the metal ion-concentration decrease portion, an ion exchange resin of the evaluation model of Example 5 which was used in the evaluation test to be described later was used, an evaluation model was obtained in a manner similar to that of Example 2.

### Example 7

Except for that the use amount of the ion exchange resin to be used for the metal ion-concentration decrease portion was decreased, and a liquid passing rate of the evaluation liquid passing through the column was increased, an evaluation model was obtained in a manner similar to that of Example 2.

### Example 8

Except for that as the ion exchange resin to be used for the metal ion-concentration decrease portion, an ion exchange resin of the evaluation model of Example 7 which was used in the evaluation test to be described later was used, an evaluation model was obtained in a manner similar to that of Example 7.

### Comparative Example 1

Except for that the ion exchange resin was omitted, and an empty column was used, an evaluation model was obtained in a manner similar to that of Example 2.

### 9. Evaluation of First Evaluation Model

9.1 Measurement of Electric Conductivity of Liquid after Passing Through Column

First, in order to measure the electric conductivity of the liquid after passing through the column, an empty beaker was placed under the column of each evaluation model.

Subsequently, the evaluation liquid was allowed to pass through the column from an upper end thereof. A liquid supply tube pump was used for the liquid supply, and a liquid supply rate was adjusted so that a dripping rate of the evaluation liquid dripping from the column was 20 cc/3 minutes.

Next, the electric conductivity of the evaluation liquid stored in the beaker was measured. The measurement results are shown in Table 2.

9.2 Evaluation of Absorption Performance of Absorbing Portion

Next, the evaluation liquid stored in the beaker in 9.1 was transferred to the above beaker in which the water absorbing resin was received. Subsequently, the evaluation liquid and the water absorbing resin in the beaker were stirred with a spoon for 60 seconds. In this step, the rate of stirring was set to 20 Hz.

After the stirring was performed, the beaker was placed upside down on non-woven cloth mesh and then left for 30 seconds. In this step, the unabsorbed evaluation liquid obtained through the non-woven cloth mesh was collected in another beaker and weighed.

The amount of the unabsorbed evaluation liquid is shown in Table 2. In addition, when the amount of the unabsorbed evaluation liquid was zero, a time required for the liquid to be fully absorbed was measured and is shown in Table 2.

In addition, the amount of the unabsorbed evaluation liquid was ranked with reference to the evaluation criteria based on the preliminary test described above. The evaluation results are shown in Table 2.

TABLE 2

| | STRUCTURE OF FIRST EVALUATION MODEL | | | | | |
|---|---|---|---|---|---|---|
| | | | | METAL ION-CONCENTRATION | | |
| | EVALUATION LIQUID | | | DECREASE PORTION | | |
| | | | ELECTRIC CONDUCTIVITY | CONCENTRATION | | LIQUID |
| | | USE | OF LIQUID BEFORE | DECREASE | USE | PASSING |
| | COMPOSITION | AMOUNT | PASSING THROUGH COLUMN | MEDIUM | AMOUNT | RATE |
| | — | cc | μS/cm | — | g | cc/min |
| EXAMPLE 1 | NaCl | 100 | 500 | CATION EXCHANGE | 4 | 10 |
| | AQUEOUS | | | RESIN | | |
| | SOLUTION | | | | | |
| EXAMPLE 2 | NaCl | 100 | 1000 | CATION EXCHANGE | 4 | 10 |
| | AQUEOUS | | | RESIN | | |
| | SOLUTION | | | | | |
| EXAMPLE 3 | NaCl | 100 | 1000 | CATION EXCHANGE | 4 | 10 |
| | AQUEOUS | | | RESIN USED IN | | |
| | SOLUTION | | | EXAMPLE 2 | | |
| EXAMPLE 4 | NaCl | 100 | 1000 | CATION EXCHANGE | 4 | 10 |
| | AQUEOUS | | | RESIN USED IN | | |
| | SOLUTION | | | EXAMPLE 3 | | |
| EXAMPLE 5 | NaCl | 100 | 1000 | CATION EXCHANGE | 4 | 10 |
| | AQUEOUS | | | RESIN USED IN | | |
| | SOLUTION | | | EXAMPLE 4 | | |
| EXAMPLE 6 | NaCl | 100 | 1000 | CATION EXCHANGE | 4 | 10 |
| | AQUEOUS | | | RESIN USED IN | | |
| | SOLUTION | | | EXAMPLE 5 | | |
| EXAMPLE 7 | NaCl | 100 | 1000 | CATION EXCHANGE | 2 | 15 |
| | AQUEOUS | | | RESIN | | |
| | SOLUTION | | | | | |
| EXAMPLE 8 | NaCl | 100 | 1000 | CATION EXCHANGE | 2 | 15 |
| | AQUEOUS | | | RESIN USED IN | | |
| | SOLUTION | | | EXAMPLE 7 | | |
| COMPARATIVE | NaCl | 100 | 1000 | NONE | 0 | — |
| EXAMPLE 1 | AQUEOUS | | | | | |
| | SOLUTION | | | | | |

| | STRUCTURE OF FIRST | EVALUATION RESULT OF FIRST EVALUATION MODEL | | | |
|---|---|---|---|---|---|
| | EVALUATION MODEL | ELECTRIC | AMOUNT OF | | |
| | ABSORBING | CONDUCTIVITY | UNABSORBED | TIME REQUIRED | |
| | PORTION | OF LIQUID | EVALUATION | FOR LIQUID | |
| | POLYMER | AFTER PASSING | LIQUID AFTER | TO BE FULLY | EVALUATION |
| | ABSORBENT | THROUGH COLUMN | 60 SECONDS | ABSORBED | RANK |
| | — | μS/cm | cc | SECONDS | — |
| EXAMPLE 1 | ANIONIC WATER | 2 | 0 | 45 | A |
| | ABSORBING | | | | |
| | RESIN | | | | |
| EXAMPLE 2 | ANIONIC WATER | 25 | 0 | 45 | A |
| | ABSORBING | | | | |
| | RESIN | | | | |
| EXAMPLE 3 | ANIONIC WATER | 90 | 0 | 52 | A |
| | ABSORBING | | | | |
| | RESIN | | | | |
| EXAMPLE 4 | ANIONIC WATER | 370 | 15.6 | — | B |
| | ABSORBING | | | | |
| | RESIN | | | | |
| EXAMPLE 5 | ANIONIC WATER | 780 | 22.2 | — | B |
| | ABSORBING | | | | |
| | RESIN | | | | |
| EXAMPLE 6 | ANIONIC WATER | 950 | 40.4 | — | C |
| | ABSORBING | | | | |
| | RESIN | | | | |
| EXAMPLE 7 | ANIONIC WATER | 100 | 0 | 45 | A |
| | ABSORBING | | | | |
| | RESIN | | | | |
| EXAMPLE 8 | ANIONIC WATER | 450 | 16.4 | — | B |
| | ABSORBING | | | | |
| | RESIN | | | | |
| COMPARATIVE | ANIONIC WATER | 1000 | 70 | — | D |
| EXAMPLE 1 | ABSORBING | | | | |
| | RESIN | | | | |

As shown in Table 2, it was found that in each example, since the metal ion-concentration decrease portion was provided, the electric conductivity of the evaluation liquid after passing through the column was decreased as compared to that of the evaluation liquid before passing through the column. In addition, when the evaluation liquid after passing through the column was absorbed in the absorbing portion, the amount of the unabsorbed evaluation liquid could be decreased as compared to that of the comparative example.

### 10. Formation of Second Evaluation Model

### Example 9

Except for that as the evaluation liquid, an ink jet printer ink ICBK-01 manufactured by Seiko Epson Corporation was used, and the conditions shown in Table 3 were used, an evaluation model was obtained in a manner similar to that of Example 1.

### Comparative Example 2

Except for that the ion exchange resin was omitted, and an empty column was used, an evaluation model was obtained in a manner similar to that of Example 9.

### 11. Evaluation of Second Evaluation Model

11.1. Measurement of Electric Conductivity of Liquid after Passing Through Column

First, in order to measure the electric conductivity of the liquid after passing through the column, an empty beaker was placed under the column of each evaluation model.

Subsequently, the evaluation liquid was allowed to pass through the column from an upper end thereof. A liquid supply tube pump was used for the liquid supply, and a liquid supply rate was adjusted so that a dripping rate of the evaluation liquid dripping from the column was 20 cc/3 minutes.

Next, the electric conductivity of the evaluation liquid stored in the beaker was measured. The evaluation results are shown in Table 3.

11.2 Evaluation of Absorption Performance of Absorbing Portion

Next, the evaluation liquid stored in the beaker in 11.1 was transferred to a beaker in which the water absorbing resin described above was received. Subsequently, the evaluation liquid and the water absorbing resin in the beaker were stirred with a spoon for 60 seconds. In this step, the rate of stirring was set to 20 Hz.

After the stirring was performed, the beaker was placed upside down on non-woven cloth mesh and then left for 30 seconds. In this step, an unabsorbed evaluation liquid obtained through the non-woven cloth mesh was collected in another beaker and weighed.

The amount of the unabsorbed evaluation liquid is shown in Table 3. In addition, the amount of the unabsorbed evaluation liquid was ranked with reference to the evaluation criteria based on the preliminary test described above. The evaluation results are shown in Table 3

TABLE 3

| | STRUCTURE OF SECOND EVALUATION MODEL | | | | | |
|---|---|---|---|---|---|---|
| | | | | METAL ION-CONCENTRATION | | |
| | EVALUATION LIQUID | | | DECREASE PORTION | | |
| | | | ELECTRIC CONDUCTIVITY | CONCENTRATION | | LIQUID |
| | | USE | OF LIQUID BEFORE | DECREASE | USE | PASSING |
| | COMPOSITION | AMOUNT | PASSING THROUGH COLUMN | MEDIUM | AMOUNT | RATE |
| | — | cc | μS/cm | — | g | cc/min |
| EXAMPLE 9 | INK | 50 | OVER 1000 | CATION EXCHANGE | 2 | 15 |
| | | | | RESIN | | |
| COMPARATIVE | INK | 50 | OVER 1000 | NONE | 0 | — |
| EXAMPLE 2 | | | | | | |

| | STRUCTURE OF SECOND | EVALUATION RESULT OF SECOND EVALUATION MODEL | | | |
|---|---|---|---|---|---|
| | EVALUATION MODEL | ELECTRIC | AMOUNT OF | | |
| | ABSORBING | CONDUCTIVITY | UNABSORBED | TIME REQUIRED | |
| | PORTION | OF LIQUID | EVALUATION | FOR LIQUID | |
| | POLYMER | AFTER PASSING | LIQUID AFTER | TO BE FULLY | EVALUATION |
| | ABSORBENT | THROUGH COLUMN | 60 SECONDS | ABSORBED | RANK |
| | — | μS/cm | cc | SECONDS | — |
| EXAMPLE 9 | ANIONIC WATER | 460 | 3 | — | B |
| | ABSORBING | | | | |
| | RESIN | | | | |
| COMPARATIVE | ANIONIC WATER | 950 | 26 | — | D |
| EXAMPLE 2 | ABSORBING | | | | |
| | RESIN | | | | |

As shown in Table 3, even when the ink jet printer ink was used instead of the sodium chloride aqueous solution, in the evaluation model of the example, a preferable absorption performance could be obtained in the absorbing portion.

What is claimed is:

1. A liquid absorption system comprising:
a pipe which transports a liquid containing metal ions;
a discharge portion which discharges the liquid transported by the pipe;
a container which recovers the liquid discharged from the discharge portion;
an absorbing portion which is received in the container and which includes a polymer absorbent absorbing the liquid; and
a metal ion-concentration decrease portion which decreases a concentration of the metal ions contained in the liquid,
wherein the metal ion-concentration decrease portion is provided at a position at which the metal ion-concentration decrease portion comes in contact with the liquid before the liquid comes in contact with the absorbing portion.

2. The liquid absorption system according to claim 1,
wherein the metal ion-concentration decrease portion is provided at the pipe or the discharge portion or between the pipe and the discharge portion.

3. The liquid absorption system according to claim 1,
wherein the absorbing portion is formed of an aggregate of small pieces each of which includes a base material containing cellulose fibers and the polymer absorbent supported by the base material.

4. The liquid absorption system according to claim 1,
wherein the polymer absorbent contains an anionic water absorbing resin, and
the metal ion-concentration decrease portion contains a cation exchange resin or an ion capture agent.

5. The liquid absorption system according to claim 1,
wherein the liquid after passing through the metal ion-concentration decrease portion has an electrical conductivity of less than 1,000 μS/cm.

6. A liquid absorption unit comprising:
a container which recovers a liquid containing metal ions introduced from an introduction portion configured to introduce the liquid;
an absorbing portion which is received in the container and which includes a polymer absorbent absorbing the liquid; and
a metal ion-concentration decrease portion which is received in the container and which decreases a concentration of the metal ions contained in the liquid,
wherein the metal ion-concentration decrease portion is provided at a position at which the metal ion-concentration decrease portion comes in contact with the liquid before the liquid comes in contact with the absorbing portion.

7. The liquid absorption unit according to claim 6,
wherein the metal ion-concentration decrease portion is disposed above the absorbing portion in a vertical direction.

8. The liquid absorption unit according to claim 6,
wherein the metal ion-concentration decrease portion is provided at an introduction position at which the liquid is introduced from the introduction portion, and
the absorbing portion is provided at a side wall side or a bottom surface side of the container than the introduction position.

9. The liquid absorption unit according to claim 6,
wherein the absorbing portion is formed of an aggregate of small pieces each of which includes a base material containing cellulose fibers and the polymer absorbent supported by the base material.

10. The liquid absorption unit according to claim 6,
wherein the polymer absorbent contains an anionic water absorbing resin, and
the metal ion-concentration decrease portion contains a cation exchange resin or an ion capture agent.

11. The liquid absorption unit according to claim 6,
wherein the liquid after coming in contact with the metal ion-concentration decrease portion has an electrical conductivity of less than 1,000 μS/cm.

12. An image forming apparatus comprising:
one of the liquid absorption system according to claim 1.

13. An image forming apparatus comprising:
one of the liquid absorption unit according to claim 6.
